(19) United States
(12) Patent Application Publication
(10) Pub. No.: US 2026/0285310 A1
(43) Pub. Date: Sep. 24, 2026

(54) METHOD FOR GENERATING VEHICLE SPEED PROFILE AND DEVICE PERFORMING SAME

(71) Applicant: 42dot Inc., Gyeonggi-do (KR)

(72) Inventors: Kyu Hwan Yeon, Gyeonggi-do (KR); Ha Young Kim, Gyeonggi-do (KR); Seong Gyun Jeong, Gyeonggi-do (KR)

(73) Assignee: 42dot Inc., Gyeonggi-do (KR)

(21) Appl. No.: 19/474,960

(22) PCT Filed: Oct. 31, 2023
(86) PCT No.: PCT/KR2023/017123

§ 371 Date: Oct. 13, 2025

(30) Foreign Application Priority Data
Apr. 14, 2023 (KR) 10-2023-0049445

(51) Int. Cl. B60W 30/16; B60W 60/00; G06N 3/09

(52) U.S. Cl. CPC B60W 30/16; B60W 60/001; G06N 3/09; B60W 2554/4042; B60W 2554/802; B60W 2720/10

(57) ABSTRACT

A method for generating a vehicle speed profile and a device performing same are disclosed. The method according to an embodiment may comprise the operations of: acquiring a plurality of input speed profiles on the basis of target vehicles located around a vehicle; generating an input array on the basis of the plurality of input speed profiles; and inputting the input array into a neural network to output a speed profile of the vehicle, corresponding to a driving route of the vehicle.

### TECHNICAL FIELD

The following description relates to a method of generating a vehicle speed profile and a device for performing the same.

### BACKGROUND ART

An autonomous vehicle may require a precise autonomous driving system to navigate complex road environments. To select an optimal driving route among possible driving routes, the autonomous driving system may evaluate a speed profile corresponding to each driving route and may consider factors such as safety, driving comfort, and/or driving efficiency. To effectively control the autonomous vehicle, the autonomous driving system may need to search for the optimal driving route and the corresponding speed profile in real time.

The above description has been possessed or acquired by the inventor(s) in the course of conceiving the present disclosure and is not necessarily an art publicly known before the present application is filed.

### DISCLOSURE OF THE INVENTION

### Technical Goals

An embodiment may generate high-quality speed profiles corresponding to a plurality of driving routes in a short period of time by generating vehicle speed profiles using a neural network that uses input speed profiles as input.

However, the technical goals are not limited to the foregoing goals, and there may be other technical goals.

### Technical Solutions

According to an embodiment, a device for generating a speed profile of a vehicle includes a memory including instructions and a processor electrically connected to the memory and configured to execute the instructions, wherein, when the instructions are executed by the processor, the processor may be configured to perform a plurality of operations, and wherein the plurality of operations may include obtaining a plurality of input speed profiles based on a target vehicle located around the vehicle, generating an input array based on the plurality of input speed profiles, and by inputting the input array to a neural network, outputting the speed profile of the vehicle corresponding to a driving route of the vehicle.

The obtaining may include calculating the plurality of input speed profiles based on one or more of a speed of a preceding vehicle of the vehicle, a speed of a following vehicle of the vehicle, a safe distance from the preceding vehicle, and a desired speed of the vehicle.

The calculating of the plurality of input speed profiles may include calculating a first input speed profile based on the speed of the preceding vehicle, calculating a second input profile based on the speed of the following vehicle, and calculating a third input speed profile based on the safe distance and the desired speed.

The outputting may include, by inputting the input array to an encoder neural network, generating an encoded array corresponding to the input array and by inputting the encoded array to a decoder neural network, outputting the speed profile corresponding to the input array.

The generating of the encoded array may include obtaining an embedded array by embedding the input array and generating the encoded array by using a cross attention layer configured to use the embedded array as a key and a value and use, as a query, a latent array having a smaller dimension than a dimension of the embedded array.

The outputting may include obtaining an output array by using a cross-attention layer configured to use the encoded array as a key and a value and use, as a query, an output query array having a same dimension as the dimension of the embedded array and outputting the speed profile based on the output array.

The neural network may be trained based on a first loss for preventing the speed profile from violating at least one of a boundary related to a preceding vehicle of the vehicle and a boundary related to a following vehicle of the vehicle.

The neural network may be trained using the first loss and a second loss calculated based on ground truth obtained using model predictive control.

A dataset used to obtain the ground truth may be obtained based on a plurality of scenarios having different difficulty levels.

The plurality of scenarios may include a scenario considering a case in which a target vehicle is not located in front or behind the vehicle and the vehicle is driving at a constant speed, a scenario considering a case in which a target vehicle is located in front of the vehicle and a safe distance is maintained between the vehicle and the target vehicle, and a scenario considering a case in which target vehicles are located in front and behind the vehicle.

According to an embodiment, a method of generating a speed profile of a vehicle includes obtaining a plurality of input speed profiles based on a target vehicle located around the vehicle, generating an input array based on the plurality of input speed profiles, and by inputting the input array to a neural network, outputting the speed profile of the vehicle corresponding to a driving route of the vehicle.

The obtaining may include calculating the plurality of input speed profiles based on one or more of a speed of a preceding vehicle of the vehicle, a speed of a following vehicle of the vehicle, a safe distance from the preceding vehicle, and a desired speed of the vehicle.

The calculating of the plurality of input speed profiles may include calculating a first input speed profile based on the speed of the preceding vehicle, calculating a second input profile based on the speed of the following vehicle, and calculating a third input speed profile based on the safe distance and the desired speed.

The outputting may include, by inputting the input array to an encoder neural network, generating an encoded array corresponding to the input array and by inputting the encoded array to a decoder neural network, outputting the speed profile corresponding to the input array.

The generating of the encoded array may include obtaining an embedded array by embedding the input array and generating the encoded array by using a cross attention layer configured to use the embedded array as a key and a value and use, as a query, a latent array having a smaller dimension than a dimension of the embedded array.

The outputting may include obtaining an output array by using a cross-attention layer configured to use the encoded array as a key and a value and use, as a query, an output query array having a same dimension as the dimension of the embedded array and outputting the speed profile based on the output array.

The neural network may be trained based on a first loss for preventing the speed profile from violating at least one of a boundary related to a preceding vehicle of the vehicle and a boundary related to a following vehicle of the vehicle.

The neural network may be trained using the first loss and a second loss calculated based on ground truth obtained using model predictive control.

A dataset used to obtain the ground truth may be obtained based on a plurality of scenarios having different difficulty levels.

The plurality of scenarios may include a scenario considering a case in which a target vehicle is not located in front or behind the vehicle and the vehicle is driving at a constant speed, a scenario considering a case in which a target vehicle is located in front of the vehicle and a safe distance is maintained between the vehicle and the target vehicle, and a scenario considering a case in which target vehicles are located in front and behind the vehicle.

### BRIEF DESCRIPTION OF DRAWINGS

FIG. 1 is a diagram illustrating an electronic device according to an embodiment.

FIG. 2 is a diagram illustrating a vehicle speed profile according to an embodiment.

FIG. 3 is a diagram illustrating an example of a neural network according to an embodiment.

FIGS. 4 and 5 are diagrams illustrating neural network training according to an embodiment.

FIG. 6 is a flowchart illustrating an operation of an electronic device, according to an embodiment.

FIG. 7 is a schematic block diagram of an electronic device according to an embodiment.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like components, and any repeated description related thereto will be omitted.

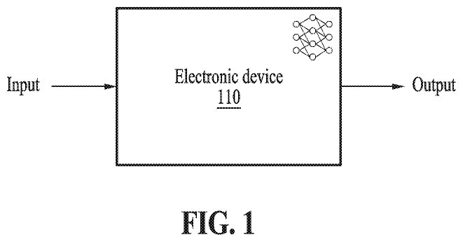

FIG. 1 is a diagram illustrating an electronic device according to an embodiment.

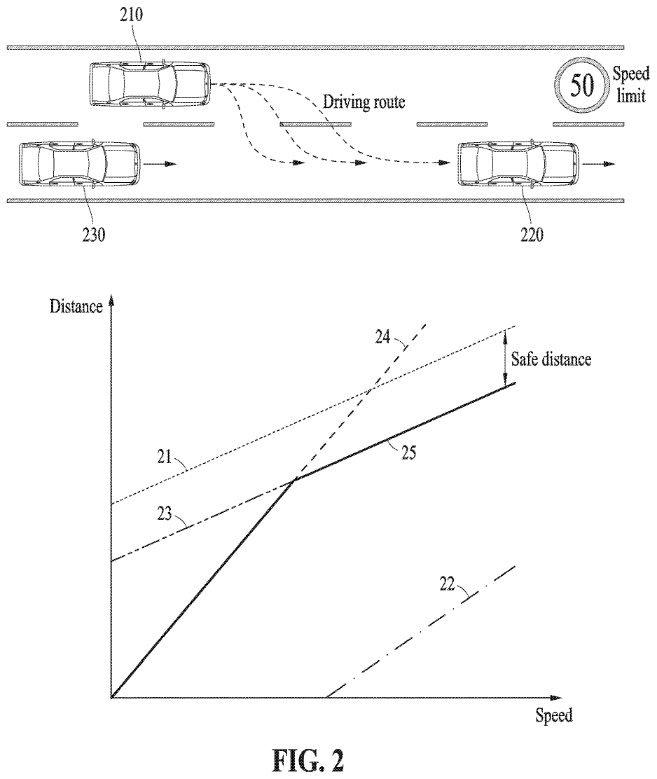

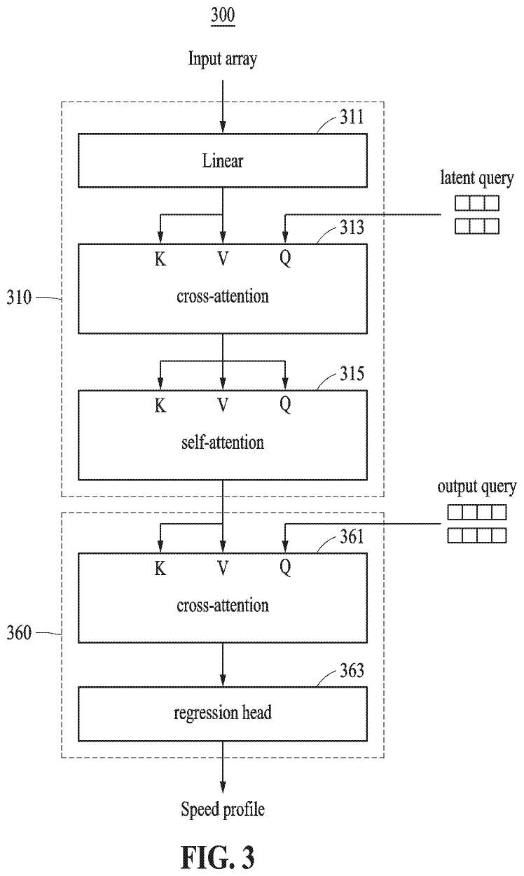

Referring to FIG. 1, according to an embodiment, an electronic device 110 may control a vehicle (e.g., a vehicle 210 of FIG. 2). The electronic device 110 may generate a speed profile corresponding to a driving route of the vehicle using a neural network (e.g., a neural network 300 of FIG. 3). In the present disclosure, the speed profile may refer to a function representing a relative distance between an initial location of the vehicle at time t=0 and a current location of the vehicle. The electronic device 110 may be located inside or outside the vehicle 210. For example, the electronic device 210 may be implemented as a server located outside the vehicle 110 and may be connected to the vehicle 210 via a network.

FIG. 2 is a diagram illustrating a vehicle speed profile according to an embodiment.

Referring to FIG. 2, according to an embodiment, an electronic device (e.g., the electronic device 110 of FIG. 1) may search for a plurality of driving routes based on driving-related information of the vehicle 210 (e.g., a desired speed and a safety distance, a speed of a preceding vehicle 220, and/or a speed of a following vehicle 230) and may generate a speed profile corresponding to each driving route. The electronic device 110 may input an input array related to an input speed profile (e.g., input speed profiles 21 to 25) to a neural network (e.g., the neural network 300 of FIG. 3) to generate an output speed profile.

The electronic device 110 may generate one or more input profiles based on the driving-related information of the vehicle 210. The first input speed profile 21 may be based on the speed of the preceding vehicle 220. The second input speed profile 22 may be based on the speed of the following vehicle 230. The third input speed profile 23 may be based on the speed of the preceding vehicle 220 and the safety distance between the preceding vehicle 220 and the vehicle 210. The fourth input speed profile 24 may be based on a desired speed of the vehicle 210. For example, the fourth input speed profile 24 may be obtained based on setting (e.g., a specific driving speed within a speed limit) of an autonomous driving system. The fifth input speed profile 25 may be based on the third input speed profile 23 and the fourth input speed profile 25. The first input speed profile 21, the second input speed profile 22, and the third input speed profile 23 may be based on a constant speed model but are not limited thereto.

FIG. 3 is a diagram illustrating an example of a neural network according to an embodiment.

Referring to FIG. 3, according to an embodiment, the neural network 300 (e.g., a transformer) may include an encoder neural network 310 and a decoder neural network 360.

The encoder neural network 310 may include a linear layer (e.g., a fully-connected layer) 311, a cross-attention block 313, and a self-attention block 315. The encoder neural network 310 may encode an input array.

The linear layer 311 may embed the input array. The input array may be generated based on an input speed profile (e.g., the input speed profiles 21 to 25 of FIG. 2). For example, when five input speed profiles 21 to 25 are used and a prediction horizon of the neural network 300 is N (e.g., N is a natural number), the input array may have the form of N×5. Here, when a special token is applied to provide initial speed information of a vehicle (e.g., the vehicle 210 of FIG. 1) to the neural network 300, the input array may have the shape of (N+1)×5. The linear layer 311 may generate an embedded array by applying an embedding process to the input array. When an embedding dimension of the linear layer 311 is D (e.g. 64), the embedded array may have the shape of (N+)×D. The embedded array may be used as a key and a value of the cross-attention block 313.

The cross-attention block 313 may perform an attention operation using an output (e.g., the embedded array) of the linear layer 311 and a latent query. The output of the linear layer 311 may be used as a key and a value of the cross-attention block 313, and the latent query may be used as a query of the cross-attention block 313. The latent query may have a dimension (e.g., 32) that is smaller than a dimension (e.g., 64) of the embedded array. The neural network 300 may quickly generate a speed profile for a long prediction horizon by using the cross-attention block 313 based on the latent query.

The self-attention block 315 may process information in a latent space using an output of the cross-attention block 313. The output of the cross-attention block 313 may be used as a key, a value, and a query of the self-attention block 315.

The decoder neural network 360 may include a cross-attention block 361 and a regression head 363.

The cross-attention block 361 may decode an output of the encoder neural network 310. The cross-attention block 361 may perform an attention operation using an encoded array (e.g., the output of the encoder neural network 310) and an output query. The output of the encoder neural network 310 may be used as a key and a value of the cross-attention block 361, and the output query may be used as a query of the cross-attention block 361. The output query may be an array that specifies a meaning of a specific output. The output query may have the same dimension as the dimension of the embedded array (e.g., the output of the linear layer 311). For example, the shape of the output query may be N×D.

The regression head 363 may output the speed profile as shown in Equation 1 by obtaining coefficients of a polynomial using an output array of the cross-attention block 361.

$$y ( t ) = {C}_{5} {t}^{5} + {C}_{4} {t}^{4} + {C}_{3} {t}^{3} + {C}_{2} {t}^{2} + {C}_{1} t \qquad [ Equation 1 ]$$

Equation 1 is an example illustrating the present disclosure, and an output of the neural network 300 may be an n-th order polynomial (e.g., n is a natural number).

The neural network 300 may be trained based on a first loss and a second loss. The first loss may be a boundary constraint loss to prevent the output of the neural network 300 from violating an upper boundary (e.g., the first input speed profile 21 of FIG. 2) and a lower boundary (e.g., the second input speed profile 22 of FIG. 2), and the second loss may be a supervised loss for an error between ground truth for the prediction horizon (e.g., 5) and the output (e.g., a predicted speed profile) of the neural network 300. For example, an overall loss function of the neural network 300 may be calculated as shown in Equation 2.

$$L = {L}_{s} + λ {L}_{Ω} \qquad [ Equation 2 ]$$

In Equation 2, L_{Ω} represents the first loss, λ represents a weight, and Lₛ represents the second loss.

The first loss may be calculated as shown in Equation 3.

$${L}_{Ω} = \frac{1}{N} {\sum }_{t = 0}^{N} ( ReLU ( {\hat{y}}_{t} - {s}_{t}^{Ub} ) + ReLU ( {s}_{t}^{Lb} - {\hat{y}}_{t} ) ) \qquad [ Equation 3 ]$$

In Equation 3, [symbol] ₜ represents the output of the neural network, 300,

$${s}_{t}^{Ub}$$

represents the upper boundary (e.g., the first input speed profile 21), and

$${s}_{t}^{Lb}$$

represents the lower boundary (e.g., the second input speed profile 22).

The second loss may be calculated as shown in Equation 4.

$${L}_{s} = \frac{1}{N} {\sum }_{t = 0}^{N} {( {\hat{y}}_{t} - {y}_{t} )}^{2} \qquad [ Equation 4 ]$$

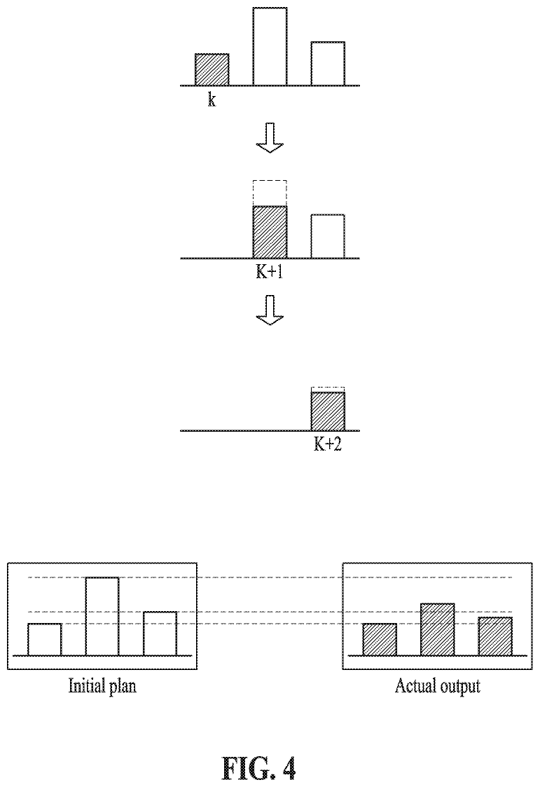

In Equation 4, [symbol] ₜ represents the output of the neural network 300, and [symbol] ₜ represents the ground truth. [symbol] ₜ may be obtained using model predictive control. The method of generating the ground truth is described in detail with reference to FIGS. 4 and 5.

FIGS. 4 and 5 are diagrams illustrating neural network training according to an embodiment. FIG. 4 is a diagram illustrating model predictive control, and FIG. 5 is a diagram illustrating a scenario for generating a dataset.

Referring to FIG. 4, according to an embodiment, ground truth for training a neural network (e.g., the neural network 300 of FIG. 3) may be obtained using the model predictive control. The model predictive control may be a control technique that uses a mathematical model of a control target system (e.g., the vehicle 210 of FIG. 2) to predict a future behavior of the system and optimizes system control based on the predicted behavior.

The model predictive control may plan a control command at a step (e.g., k, k+1, and k+2) corresponding to a prediction horizon by using a system state at a previous step k−1. The model predictive control may output the control command (e.g., a control command for a current step k planned at the previous step k−1) corresponding to a current step k and may receive feedback on a result (e.g., a system state at the current step k). The model predictive control may update an objective function based on the feedback and may plan the control command for a next step (e.g., k+1 and k+2) based on the updated objective function.

For example, system dynamics may be expressed as a location sₜ of the vehicle 210, a speed vₜ of the vehicle 210, and an acceleration aₜ of the vehicle 210, as shown in Equation 5.

$${X}_{t} = [ \begin{matrix}{s}_{t} \\ {v}_{t} \\ {a}_{t}\end{matrix} ] , A = [ \begin{matrix}1 & dt & \frac{1}{2} {dt}^{2} \\ 0 & 1 & dt \\ 0 & 0 & 1\end{matrix} ] , B = [ \begin{matrix}\frac{1}{6} {dt}^{3} \\ \frac{1}{2} {dt}^{2} \\ dt\end{matrix} ] , {U}_{t} = {u}_{t} \qquad [ Equation 5 ]$$

In Equation 5, A represents a state transition matrix, B represents a control input matrix, and Uₜ represents jerkiness related to driving discomfort.

The model predictive control may minimize the objective function J in the prediction horizon N, as shown in Equation 6. The objective function J may include terms for location errors, acceleration, and/or jerkiness.

$${min}_{u} J = {\sum }_{t = 0}^{N} ( {e}_{t}^{T} {W}_{s} {e}_{t} + {a}_{t}^{T} {W}_{a} {a}_{t} ) + {\sum }_{t = 0}^{N - 1} {u}_{t}^{T} {W}_{u} {u}_{t} \qquad [ Equation 6 ]$$

In Equation 6, Wₛ, Wₐ, and Wᵤ represent weights, and eₜ represents a location error. The location error may be calculated based on a difference between a reference location and an actual location.

The model predictive control may determine a next state of the vehicle 210 based on a current state and a control input using a state transition equation, as shown in Equation 7.

$${X}_{t + 1} = {A}_{t} {X}_{t} + {BU}_{t} \qquad [ Equation 7 ]$$

$${s}_{t}^{Lb} \leq {s}_{t} \leq {s}_{t}^{Ub}$$

$${a}_{m i n} \leq {a}_{t} \leq {a}_{ma x}$$

$${u}_{m i n} \leq {u}_{t} \leq {u}_{m ax}$$

Referring to FIG. 5, according to an embodiment, a dataset for training may be obtained based on a plurality of scenarios having different difficulty levels. For example, the dataset may be obtained based on a first scenario 510, a second scenario 520, and a third scenario 530. The first scenario 510 may be a scenario considering a case in which a target vehicle is not located in front or behind a vehicle (e.g., the vehicle 210 of FIG. 2) and the vehicle 210 is driving at a constant speed. The second scenario 520 may be a scenario considering a case in which the target vehicle 220 is located in front of the vehicle 210 and a safe distance is maintained between the target vehicle 220 and the vehicle 210. The third scenario 530 may be a scenario considering a case in which the target vehicles 220 and 230 are located in front and behind the vehicle 210.

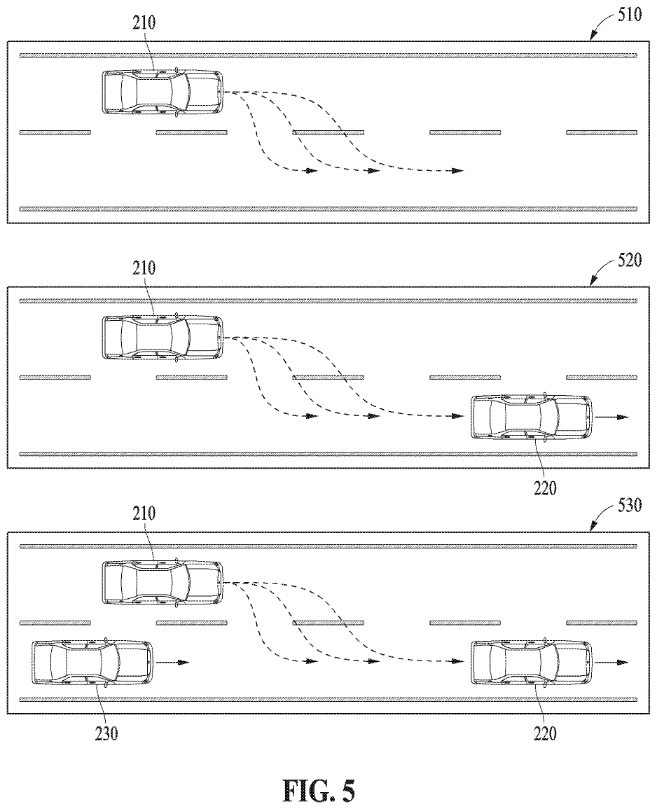

FIG. 6 is a flowchart illustrating an operation of an electronic device, according to an embodiment.

Referring to FIG. 6, operations 610 to 630 may be sequentially performed, but embodiments are not limited thereto. For example, two or more operations may be performed in parallel. Operations 610 to 630 may be substantially the same as the operations of an electronic device (e.g., the electronic device 110 of FIG. 1) described with reference to FIGS. 1 to 5. Accordingly, further description thereof is not repeated herein.

In operation 610, the electronic device 110 may obtain a plurality of input speed profiles (e.g., the input speed profiles 21 to 25 of FIG. 2) based on a target vehicle (e.g., the preceding vehicle 220 and the following vehicle 230 of FIG. 2) located around a vehicle (e.g., the vehicle 210 of FIG. 2).

In operation 620, the electronic device 110 may generate an input array based on the plurality of input speed profiles 21 to 25.

In operation 630, the electronic device 110 may input the input array to a neural network (e.g., the neural network 300 of FIG. 3) to output a speed profile of the vehicle 210 corresponding to a driving route of the vehicle 210.

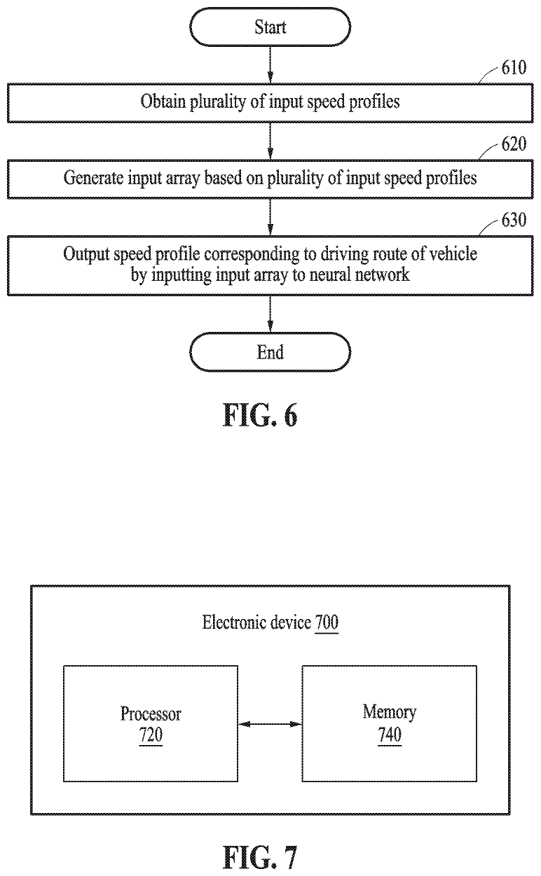

FIG. 7 is a schematic block diagram of an electronic device according to an embodiment.

Referring to FIG. 7, according to an embodiment, an electronic device 700 (e.g., the electronic device 110 of FIG. 1) may include a memory 740 and a processor 720.

The memory 740 may store instructions (or programs) executable by the processor 720. For example, the instructions may include instructions for executing an operation of the processor 720 and/or an operation of each component of the processor 720.

The memory 740 may include one or more computer-readable storage media. The memory 740 may include non-volatile storage elements (e.g., a magnetic hard disc, an optical disc, a floppy disc, flash memory, electrically programmable memory (EPROM), and electrically erasable and programmable memory (EEPROM)).

The memory 740 may be a non-transitory medium. The term “non-transitory” may indicate that a storage medium is not embodied in a carrier wave or a propagated signal. However, the term “non-transitory” should not be interpreted to mean that the memory 740 is non-movable.

The processor 720 may process data stored in the memory 740. The processor 720 may execute computer-readable code (e.g., software) stored in the memory 740 and instructions triggered by the processor 720.

The processor 720 may be a hardware-implemented data processing device having a circuit that is physically structured to execute desired operations. For example, the desired operations may include code or instructions included in a program.

The hardware-implemented data processing device may include, for example, a microprocessor, a central processing unit (CPU), a processor core, a multi-core processor, a multiprocessor, an ASIC, and an FPGA.

An operation performed by the processor 720 may be substantially the same as the operation of the electronic device 110 described with reference to FIGS. 1 to 6. Accordingly, further description thereof is not repeated herein.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. A device for generating a speed profile of a vehicle, the device comprising:
a memory comprising instructions; and
a processor electrically connected to the memory and configured to execute the instructions,
wherein, when the instructions are executed by the processor, the processor is configured to perform a plurality of operations, and
wherein the plurality of operations comprises:
obtaining a plurality of input speed profiles based on a target vehicle located around the vehicle;
generating an input array based on the plurality of input speed profiles; and
by inputting the input array to a neural network, outputting the speed profile of the vehicle corresponding to a driving route of the vehicle.

2. The device of claim 1, wherein
the obtaining comprises calculating the plurality of input speed profiles based on one or more of a speed of a preceding vehicle of the vehicle, a speed of a following vehicle of the vehicle, a safe distance from the preceding vehicle, and a desired speed of the vehicle.

3. The device of claim 2, wherein
the calculating of the plurality of input speed profiles comprises:
calculating a first input speed profile based on the speed of the preceding vehicle;
calculating a second input profile based on the speed of the following vehicle; and
calculating a third input speed profile based on the safe distance and the desired speed.

4. The device of claim 1, wherein
the outputting comprises:
by inputting the input array to an encoder neural network, generating an encoded array corresponding to the input array; and
by inputting the encoded array to a decoder neural network, outputting the speed profile corresponding to the input array.

5. The device of claim 4, wherein
the generating of the encoded array comprises:
in obtaining an embedded array by embedding the input array; and
generating the encoded array by using a cross attention layer configured to use the embedded array as a key and a value and use, as a query, a latent array having a smaller dimension than a dimension of the embedded array.

6. The device of claim 5, wherein
the outputting comprises:
obtaining an output array by using a cross-attention layer configured to use the encoded array as a key and a value and use, as a query, an output query array having a same dimension as the dimension of the embedded array; and
outputting the speed profile based on the output array.

7. The device of claim 1, wherein
the neural network is trained based on a first loss for preventing the speed profile from violating at least one of a boundary related to a preceding vehicle of the vehicle and a boundary related to a following vehicle of the vehicle.

8. The device of claim 7, wherein
the neural network is trained using the first loss and a second loss calculated based on ground truth obtained using model predictive control.

9. The device of claim 8, wherein
a dataset used to obtain the ground truth is obtained based on a plurality of scenarios having different difficulty levels.

10. The device of claim 9, wherein
the plurality of scenarios comprises:
a scenario considering a case in which a target vehicle is not located in front or behind the vehicle and the vehicle is driving at a constant speed;
a scenario considering a case in which a target vehicle is located in front of the vehicle and a safe distance is maintained between the vehicle and the target vehicle; and
a scenario considering a case in which target vehicles are located in front and behind the vehicle.

11. A method of generating a speed profile of a vehicle, the method comprising:
obtaining a plurality of input speed profiles based on a target vehicle located around the vehicle;
generating an input array based on the plurality of input speed profiles; and
by inputting the input array to a neural network, outputting the speed profile of the vehicle corresponding to a driving route of the vehicle.

12. The method of claim 11, wherein
the obtaining comprises calculating the plurality of input speed profiles based on one or more of a speed of a preceding vehicle of the vehicle, a speed of a following vehicle of the vehicle, a safe distance from the preceding vehicle, and a desired speed of the vehicle.

13. The method of claim 12, wherein
the calculating of the plurality of input speed profiles comprises:
calculating a first input speed profile based on the speed of the preceding vehicle;
calculating a second input profile based on the speed of the following vehicle; and
calculating a third input speed profile based on the safe distance and the desired speed.

14. The method of claim 11, wherein
the outputting comprises:
by inputting the input array to an encoder neural network, generating an encoded array corresponding to the input array; and
by inputting the encoded array to a decoder neural network, outputting the speed profile corresponding to the input array.

15. The method of claim 14, wherein
the generating of the encoded array comprises:
obtaining an embedded array by embedding the input array; and
generating the encoded array by using a cross attention layer configured to use the embedded array as a key and a value and use, as a query, a latent array having a smaller dimension than a dimension of the embedded array.

16. The method of claim 15, wherein
the outputting comprises:
obtaining an output array by using a cross-attention layer configured to use the encoded array as a key and a value and use, as a query, an output query array having a same dimension as the dimension of the embedded array; and
outputting the speed profile based on the output array.

17. The method of claim 11, wherein
the neural network is trained based on a first loss for preventing the speed profile from violating at least one of a boundary related to a preceding vehicle of the vehicle and a boundary related to a following vehicle of the vehicle.

18. The method of claim 17, wherein
the neural network is trained using the first loss and a second loss calculated based on ground truth obtained using model predictive control.

19. The method of claim 18, wherein
a dataset used to obtain the ground truth is obtained based on a plurality of scenarios having different difficulty levels.

20. The method of claim 19, wherein
the plurality of scenarios comprises:
a scenario considering a case in which a target vehicle is not located in front or behind the vehicle and the vehicle is driving at a constant speed;
a scenario considering a case in which a target vehicle is located in front of the vehicle and a safe distance is maintained between the vehicle and the target vehicle; and
a scenario considering a case in which target vehicles are located in front and behind the vehicle.
